(19) United States
(12) Patent Application Publication
(10) Pub. No.: US 2021/0014484 A1
(43) Pub. Date: Jan. 14, 2021

(54) PICTURE ENCODING AND DECODING, PICTURE ENCODER, AND PICTURE DECODER

(71) Applicant: HUAWEI TECHNOLOGIES CO., LTD., Shenzhen (CN)

(72) Inventors: Anand Meher Kotra, Munich (DE); Zhijie Zhao, Munich (DE); Semih Esenlik, Munich (DE); Han Gao, Munich (DE)

(21) Appl. No.: 17/037,550

(22) Filed: Sep. 29, 2020

Related U.S. Application Data
(63) Continuation of application No. PCT/CN2018/081176, filed on Mar. 29, 2018.

(51) Int. Cl. H04N 19/105; H04N 19/159; H04N 19/189; H04N 19/176

(52) U.S. Cl. CPC H04N 19/105; H04N 19/176; H04N 19/189; H04N 19/159

(57) ABSTRACT

The disclosure relates to a decoder for reconstructing a current block of an encoded picture, the decoder comprising processing circuitry configured to generate a most probable modes (MPM) candidates list for the current block, the MPM candidates list comprising four or more elements, wherein the first four elements of the MPM candidates list are, in this order, an intra-prediction mode associated with a left neighboring block of the current block, an intra-prediction mode associated with a top neighboring block of the current block, a planar mode, and an intra-prediction mode associated with a top-left neighboring block of the current block, prune the MPM candidates list, thereby generating an MPM list, and intra-predict the current block based on the MPM list. A higher compression ratio can thus be achieved.

### CROSS-REFERENCE TO RELATED APPLICATIONS

This application is a continuation of International Application No. PCT/CN2018/081176, filed on Mar. 29, 2018, the disclosure of which is hereby incorporated by reference in its entirety.

### TECHNICAL FIELD

Embodiments of the present disclosure relate to the field of picture processing, for example still picture and/or video picture coding. Further embodiments of the present disclosure relate to coding techniques associated with the intra-prediction mode.

### BACKGROUND

Since the development of the block-based hybrid video coding approach in the H.261 standard in 1990, new video coding techniques and tools have been developed and form the basis of new video coding standards. Most of the video coding standards were developed to improve video coding for picture processing and to achieve a bit rate reduction compared to their predecessors without sacrificing picture quality. Further video coding standards comprise MPEG-1 video, MPEG-2 video, ITU-T H.262/MPEG-2, ITU-T H.263, ITU-T H.264/MPEG-4, Part 10, Advanced Video Coding (AVC), ITU-T H.265, High Efficiency Video Coding (HEVC), and extensions, e.g. scalability and/or three-dimensional (3D) extensions, of these standards.

Intra-prediction exploits spatial correlation within a picture. In order to improve coding efficiency, the high efficiency video coding (HEVC) standard has been developed using block-based spatial prediction. In HEVC, multiple intra-prediction modes are used to exploit spatial features. For example, the number of intra-prediction modes can be as many as 67, including 65 directional intra prediction modes, one DC mode and one planar mode. Although increasing the number of directional intra modes improves the spatial prediction, this disadvantageously increases the signaling overhead. A signaling mechanism based on most probable modes (MPM) is used to reduce the signaling overhead for intra mode signaling.

### SUMMARY

The present disclosure aims to improve the state of the art. In particular, an object of the present disclosure is to provide an improved intra-prediction signaling mechanism to increase the coding gain.

The above-mentioned object is achieved by the features of the independent claims. Further embodiments of the disclosure are apparent from the dependent claims, the description and the figures.

According to a first aspect, the disclosure relates to a decoder for reconstructing a current block of an encoded picture. The decoder comprises processing circuitry configured to generate a most probable modes (MPM) candidates list for the current block. The MPM candidates list comprises four or more elements. The first four elements of the MPM candidates list are, in this order, an intra-prediction mode associated with a left neighboring block of the current block, an intra-prediction mode associated with a top neighboring block of the current block, a planar mode, and an intra-prediction mode associated with a top-left neighboring block of the current block. The processing circuitry is configured to prune the MPM candidates list, thereby generating an MPM list. The processing circuitry is configured to intra-predict the current block based on the MPM list.

Thereby, this results in an advantageously improved compression performance and reduced bitrate at same quality. Introducing the MPM candidates list improves the efficiency of the prediction process, because missing neighboring blocks for reconstructing a current block no longer significantly impact the prediction process.

In this application, it is understood that the MPM list is an ordered list of modes. Any mode may be listed in the MPM list at most once (thus the modes in the MPM list are all different from one another).

Pruning the MPM candidates list comprises or consists in skipping the following elements (i.e. entries or items) of the MPM candidates list: undefined elements (e.g., elements defined with reference to an unavailable or non-existent neighboring block), and any element which is a mode already listed at a higher position (i.e. as a preceding element) in the MPM candidates list. A sub list comprising only mutually different, defined elements is thus obtained. Thus it is ensured that the MPM list contains only well-defined modes and that each mode in the MPM list is contained in the MPM list only once. The intra-prediction mode selected for the current block can thus be signaled in an efficient manner.

Further, Pruning the MPM candidates list may comprise truncating that sub list so that the resulting list, namely, the MPM list, has a desired, predefined length (i.e. a desired, predefined total number of modes). This length may, for example, be 4 or 5 or 6 or 7.

Intra-predicting a block means generating a prediction of the block, i.e. computing sample values of the block based on reference samples of the block, using an intra-prediction mode. The final block can be reconstructed by adding a residual (from the encoded picture) to the prediction of the block.

According to an implementation of the decoder according to the first aspect, the MPM candidates list comprises five or more elements. The fifth element of the MPM candidates list is an intra-prediction mode associated with a top-right neighboring block of the current block.

Thereby, this results in a further advantageous improvement of the compression efficiency.

According to a further implementation of the decoder according to the first aspect, the MPM candidates list comprises six or more elements, the sixth element of the MPM candidates list being a bottom-left neighboring block of the current block.

Thereby, the MPM list is constructed in an efficient way to advantageously reduce the signaling overhead.

According to a further implementation of the decoder according to the first aspect, the MPM candidates list comprises seven or more elements, the seventh element of the MPM candidates list being a DC mode.

Thereby, less bits are advantageously spent for signaling the intra-prediction modes. Increasing the number of intra prediction modes advantageously provides better prediction results.

According to a second aspect, the disclosure relates to a method for reconstructing a current block of an encoded picture, the method comprises the step of generating a most probable modes (MPM) candidates list for the current block. The MPM candidates list comprises four or more elements, wherein the first four elements of the MPM candidates list are, in this order, an intra-prediction mode associated with a left neighboring block of the current block, an intra-prediction mode associated with a top neighboring block of the current block, a planar mode, and an intra-prediction mode associated with a top-left neighboring block of the current block. The method further comprises the step of pruning the MPM candidates list, thereby generating an MPM list. The method further comprises the step of intra-predicting the current block based on the MPM list.

Thereby, this results in an advantageously improved compression performance and reduced bitrate at same quality. Introducing the MPM candidates list improves the efficiency of the prediction process, because missing neighboring blocks for reconstructing a current block no longer significantly impact the prediction process.

According to an implementation of the method according to the second aspect, the MPM candidates list comprises five or more elements. The fifth element of the MPM candidates list is an intra-prediction mode associated with a top-right neighboring block of the current block.

Thereby, this results in a further advantageous improvement of the compression efficiency.

According to a further implementation of the method according to the second aspect, the MPM candidates list comprises six or more elements, the sixth element of the MPM candidates list being a bottom-left neighboring block of the current block.

Thereby, the MPM list is constructed in an efficient way to advantageously reduce the signaling overhead.

According to a further implementation of the method according to the second aspect, the MPM candidates list comprises seven or more elements, the seventh element of the MPM candidates list being a DC mode.

Thereby, less bits are advantageously spent for signaling the intra-prediction modes. Increasing the number of intra prediction modes advantageously provides better prediction results.

According to a third aspect, the disclosure relates to an encoder for encoding a current block of a picture. The encoder comprises processing circuitry. The processing circuitry is configured to generate a most probable modes (MPM) candidates list for the current block. The MPM candidates list comprises four or more elements. The first four elements of the MPM candidates list are, in this order, an intra-prediction mode associated with a left neighboring block of the current block, an intra-prediction mode associated with a top neighboring block of the current block, a planar mode, and an intra-prediction mode associated with a top-left neighboring block of the current block. The processing circuitry is further configured to prune the MPM candidates list, thereby generating an MPM list. The Processing circuitry is further configured to intra-predict the current block based on the MPM list.

Thereby, advantageously less bits are spent for signaling the intra-prediction modes. Further, this results in an advantageously improved compression performance or reduced bitrate at same quality.

Introducing the MPM candidates list improves the efficiency of the prediction process, because missing neighboring blocks for reconstructing a current block no longer significantly impact the prediction process.

According to an implementation of the encoder according to the third aspect, the MPM candidates list comprises five or more elements, the fifth element of the MPM candidates list being an intra-prediction mode associated with a top-right neighboring block of the current block.

According to a further implementation of the encoder according to the third aspect, the MPM candidates list comprises six or more elements, the sixth element of the MPM candidates list being a bottom-left neighboring block of the current block.

According to a further implementation of the encoder according to the third aspect, the MPM candidates list comprises seven or more elements, the seventh element of the MPM candidates list being a DC mode.

Thereby, the MPM list is constructed in an efficient way to advantageously reduce the signaling overhead.

According to a fourth aspect, the disclosure relates to a method for encoding a current block of a picture. The method comprises the step of generating a most probable modes (MPM) candidates list for the current block. The MPM candidates list comprises four or more elements. The first four elements of the MPM candidates list are, in this order, an intra-prediction mode associated with a left neighboring block of the current block, an intra-prediction mode associated with a top neighboring block of the current block, a planar mode, and an intra-prediction mode associated with a top-left neighboring block of the current block. The method further comprises the step of pruning the MPM candidates list, thereby generating an MPM list. The method further comprises the step of intra-predicting the current block based on the MPM list.

Thereby, this results in an advantageously improved compression performance and reduced bitrate at same quality. Introducing the MPM candidates list improves the efficiency of the prediction process, because missing neighboring blocks for reconstructing a current block no longer significantly impact the prediction process.

According to an implementation of the method according to the fourth aspect, the MPM candidates list comprises five or more elements, the fifth element of the MPM candidates list being an intra-prediction mode associated with a top-right neighboring block of the current block.

According to a further implementation of the method according to the fourth aspect, the MPM candidates list comprises six or more elements, the sixth element of the MPM candidates list being a bottom-left neighboring block of the current block.

According to a further implementation of the method according to the fourth aspect, the MPM candidates list comprises seven or more elements, the seventh element of the MPM candidates list being a DC mode.

According to a fifth aspect, the disclosure relates to the decoder for reconstructing a current block of an encoded picture. The decoder comprises processing circuitry, which is configured to generate a most probable modes (MPM) candidates list for the current block. The MPM candidates list comprises, in this order, a first list comprising one or more intra-prediction modes associated with neighboring blocks of the current block, a planar mode, and a DC mode. If the first list does not comprise any angular modes, the MPM candidates list further comprises a second list, which comprises one or more angular modes. The MPM candidates list further comprises a default mode list which comprises, in the following order: a vertical intra-prediction mode, a horizontal intra-prediction mode, an intra-prediction mode 2, and a vertical-diagonal (VDIA) intra-prediction mode. The processing circuitry is further configured to prune the MPM candidates list, thereby generating an MPM list. The processing circuitry is further configured to intra-predict the current block based on the MPM list.

Thereby, using the default mode list comprising the re-ordered list of intra-prediction modes reduces significantly the number of bits for signaling intra-prediction modes.

According to an implementation of the decoder according to the fifth aspect, the first thirteen members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1}.

According to a further implementation of the decoder according to the fifth aspect, the first sixty-five members of the default mode list are the following, in this order,

{VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

Thereby, using the default mode list comprising the re-ordered list of intra-prediction modes reduces significantly the number of bits for signaling intra-prediction modes.

According to a sixth aspect, the disclosure relates to a method for reconstructing a current block of an encoded picture, the method comprising the step of generating a most probable modes (MPM) candidates list for the current block. The MPM candidates list comprises, in this order a first list comprising one or more intra-prediction modes associated with neighboring blocks of the current block a planar mode, and a DC mode. If the first list comprises one or more angular modes, then the MPM candidates list comprises of a second list, which comprises one or more angular modes, and the MPM candidates list comprises a default mode list which comprises, in the following order: a vertical intra-prediction mode, a horizontal intra-prediction mode, an intra-prediction mode 2, and a vertical-diagonal (VDIA) intra-prediction mode. The method further comprises the step of pruning the MPM candidates list, thereby generating an MPM list. The method further comprises the step of intra-predicting the current block based on the MPM list.

Thereby, using the default mode list comprising the re-ordered list of intra-prediction modes reduces significantly the number of bits for signaling intra-prediction modes.

According to an implementation of the method according to the sixth aspect, the first thirteen members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1}.

According to a further implementation of the method according to the sixth aspect, the first sixty-five members of the default mode list are the following, in this order,

{VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

Thereby, using the default mode list comprising the re-ordered list of intra-prediction modes reduces significantly the number of bits for signaling intra-prediction modes.

According to a seventh aspect, the disclosure relates to an encoder for encoding a current block of a picture. The encoder comprises processing circuitry, which is configured to generate a most probable modes (MPM) candidates list for the current block. The MPM candidates list comprises, in this order a first list comprising one or more intra-prediction modes associated with neighboring blocks of the current block, a planar mode, and a DC mode. If the first list comprises one or more angular modes, then the MPM candidates list comprises a second list, which comprises one or more angular modes. The MPM candidates list comprises a default mode list, which comprises, in the following order: a vertical intra-prediction mode, a horizontal intra-prediction mode, an intra-prediction mode 2, and a vertical-diagonal (VDIA) intra-prediction mode. The processing circuitry is further configured to prune the MPM candidates list, thereby generating an MPM list. The processing circuitry is further configured to intra-predict the current block based on the MPM list.

Thereby, using the default mode list comprising the re-ordered list of intra-prediction modes reduces significantly the number of bits for signaling intra-prediction modes.

According to an implementation of the encoder of the seventh aspect, the first thirteen members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3 HOR_IDX−1}.

According to a further implementation of the encoder of the seventh aspect, the first sixty-five members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

Thereby, using the default mode list comprising the re-ordered list of intra-prediction modes reduces significantly the number of bits for signaling intra-prediction modes.

According to an eighth aspect, the disclosure relates to a method for encoding a current block of a picture. The method comprises the step of generating a most probable modes (MPM) candidates list for the current block. The MPM candidates list comprises, in this order, a first list comprising one or more intra-prediction modes associated with neighboring blocks of the current block, a planar mode, and a DC mode. If the first list comprises one or more angular modes, then the MPM candidates list comprises a second list, which comprises one or more angular modes. And the MPM candidates list comprises a default mode list, which comprises, in the following order: a vertical intra-prediction mode, a horizontal intra-prediction mode, an intra-prediction mode 2, and a vertical-diagonal (VDIA) intra-prediction mode, pruning the MPM candidates list, thereby generating an MPM list. The method further comprises the step of intra-predicting the current block based on the MPM list.

Thereby, using the default mode list comprising the re-ordered list of intra-prediction modes reduces significantly the number of bits for signaling intra-prediction modes.

According to an implementation of the method of the eighth aspect, the first thirteen members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1}.

According to a further implementation of the method of the eighth aspect, the first sixty-five members of the default mode list are the following, in this order, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

Thereby, using the default mode list comprising the re-ordered list of intra-prediction modes reduces significantly the number of bits for signaling intra-prediction modes.

According to a ninth aspect, the disclosure relates to a decoder for reconstructing a current block of an encoded picture. The decoder comprises processing circuitry, which is configured to generate a selected and non-selected modes list for the current block. Wherein generating the selected and non-selected modes list comprises, if the MPM list comprises one or two angular modes, the processing circuitry is further configured to incorporate one or more angular modes into the selected and non-selected modes list by adding integer multiples of an integer constant to a first angular mode. The first angular mode being the angular mode that comes first in the MPM list. The processing circuitry is further configured to incorporate one or more angular modes to the selected and non-selected modes list by adding integer multiples of the integer constant to a second angular mode. The second angular mode being the angular mode that comes second in the MPM list. The processing circuitry is further configured to intra-predict the current block based on the selected and non-selected modes list.

Thereby, advantageously less bits are spent for signaling the intra-prediction modes. This results in an improvement of the compression efficiency.

According to an implementation of the decoder of the ninth aspect, the selected and non-selected modes list comprises, in this order, a selected modes list and a non-selected modes list, and wherein the processing circuitry is configured to complete the non-selected modes list by filling it from a default mode list, wherein the default mode list is, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}

Filling comprises pruning. That is, any modes already included in the MPM list or in the selected modes list or at higher positions in the non-selected modes list will be skipped, thus avoiding redundancy in the generated lists.

According to a further implementation of the decoder of the ninth aspect, the integer constant is one.

According to a further implementation of the decoder of the ninth aspect, the integer constant is two.

According to a tenth aspect, the disclosure relates to a method for reconstructing a current block of an encoded picture. The method comprises the step of generating a selected and non-selected modes list for the current block. Generating the selected and non-selected modes list comprises, if the MPM list comprises one or two angular modes, the method further comprises the step of incorporating one or more angular modes into the selected and non-selected modes list by adding integer multiples of an integer constant to a first angular mode. The first angular mode being the angular mode that comes first in the MPM list. The method further comprises the step of incorporating one or more angular modes to the selected and non-selected modes list by adding integer multiples of the integer constant to a second angular mode. The second angular mode being the angular mode that comes second in the MPM list. The method further comprises the step of intra-predicting the current block based on the selected and non-selected modes list.

Thereby, advantageously less bits are spent for signaling the intra-prediction modes. This results in an improvement of the compression efficiency.

According to an implementation of the method of the tenth aspect, the selected and non-selected modes list comprises, in this order, a selected modes list and anon-selected modes list, and wherein the processing circuitry is configured to complete the non-selected modes list by filling it from a default mode list, wherein the default mode list is, {VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}

Filling comprises pruning. That is, any modes already included in the MPM list or in the selected modes list or at higher positions in the non-selected modes list will be skipped, thus avoiding redundancy in the generated lists.

According to a further implementation of the method of the tenth aspect, the integer constant is one.

According to a further implementation of the method of the tenth aspect, the integer constant is two.

According to an eleventh aspect, the disclosure relates to an encoder for encoding a current block of a picture. The encoder comprises processing circuitry, which is configured to generate a selected and non-selected modes list for the current block. Wherein generating the selected and non-selected modes list comprises, if the MPM list comprises one or two angular modes, the processing circuitry is further configured to incorporate one or more angular modes into the selected and non-selected modes list by adding integer multiples of an integer constant to a first angular mode. The first angular mode being the angular mode that comes first in the MPM list. The processing circuitry is further configured to incorporate one or more angular modes to the selected and non-selected modes list by adding integer multiples of the integer constant to a second angular mode. The second angular mode being the angular mode that comes second in the MPM list. The processing circuitry is further configured to intra-predict the current block based on the selected and non-selected modes list.

Thereby, advantageously less bits are spent for signaling the intra-prediction modes. This results in an improvement of the compression efficiency.

According to an implementation of the encoder according to the eleventh aspect, the integer constant is one.

According to a further implementation of the encoder according to the eleventh aspect, the integer constant is two.

According to a twelfth aspect, the disclosure relates to a method for encoding a current block of a picture. The method comprises the step of generating a selected and non-selected modes list for the current block. Generating the selected and non-selected modes list comprises, if the MPM list comprises one or two angular modes, the method further comprises the step of incorporating one or more angular modes into the selected and non-selected modes list by adding integer multiples of an integer constant to a first angular mode. The first angular mode being the angular mode that comes first in the MPM list. The method further comprises the step of incorporating one or more angular modes to the selected and non-selected modes list by adding integer multiples of the integer constant to a second angular mode. The second angular mode being the angular mode that comes second in the MPM list. The method further comprises the step of intra-predicting the current block based on the selected and non-selected modes list.

Thereby, advantageously less bits are spent for signaling the intra-prediction modes. This results in an improvement of the compression efficiency.

According to an implementation of the method according to the twelfth aspect, the integer constant is one.

According to a further implementation of the method according to the twelfth aspect, the integer constant is two.

Details of one or more embodiments are set forth in the accompanying drawings and the description below. Other features, objects, and advantages will be apparent from the description, drawings, and claims.

### BRIEF DESCRIPTION OF THE DRAWINGS

In the following embodiments of the disclosure are described in more detail with reference to the attached figures and drawings, in which:

FIG. 1 is a block diagram showing an example of a video encoder configured;

FIG. 2 is a block diagram showing an example structure of a video decoder;

FIG. 3 is a schematic diagram showing an example order of neighboring blocks used for reconstructing a current block of an encoded picture;

FIG. 4 is a flow chart illustrating procedures performed in an example of an encoder;

FIG. 5 is a flow chart illustrating procedures performed in an example of a decoder.

### DETAILED DESCRIPTION OF THE EMBODIMENTS

In the following description, reference is made to the accompanying figures, which form part of the disclosure, and which show, by way of illustration, specific aspects of embodiments of the disclosure or specific aspects in which embodiments of the present disclosure may be used. It is understood that embodiments of the disclosure may be used in other aspects and comprise structural or logical changes not depicted in the figures. The following detailed description, therefore, is not to be taken in a limiting sense, and the scope of the present disclosure is defined by the appended claims.

Video coding typically refers to the processing of a sequence of pictures, which form the video or video sequence. Video coding comprises two parts, video encoding and video decoding. Video encoding is performed at the source side, typically comprising processing (e.g. by compression) the original video pictures to reduce the amount of data required for representing the video pictures (for more efficient storage and/or transmission). Video decoding is performed at the destination side and typically comprises the inverse processing compared to the encoder to reconstruct the video pictures. Embodiments referring to “coding” of video pictures (or pictures in general, as will be explained later) shall be understood to relate to both, “encoding” and “decoding” of video pictures. The combination of the encoding part and the decoding part is also referred to as CODEC (COding and DECoding).

Several video coding standards since H.261 belong to the group of “lossy hybrid video codecs” (i.e. combine spatial and temporal prediction in the sample domain and 2D transform coding for applying quantization in the transform domain). Each picture of a video sequence is typically partitioned into a set of non-overlapping blocks and the coding is typically performed on a block level. In other words, at the encoder the video is typically processed, i.e. encoded, on a block (video block) level, e.g. by using spatial (intra picture) prediction and temporal (inter picture) prediction to generate a prediction block, subtracting the prediction block from the current block (block currently processed/to be processed) to obtain a residual block, transforming the residual block and quantizing the residual block in the transform domain to reduce the amount of data to be transmitted (compression), whereas at the decoder the inverse processing compared to the encoder is applied to the encoded or compressed block to reconstruct the current block for representation.

As video picture processing (also referred to as moving picture processing) and still picture processing (the term processing comprising coding), share many concepts and technologies or tools, in the following the term “picture” is used to refer to a video picture of a video sequence (as explained above) and/or to a still picture to avoid unnecessary repetitions and distinctions between video pictures and still pictures, where not necessary. In case the description refers to still pictures (or still images) only, the term “still picture” shall be used.

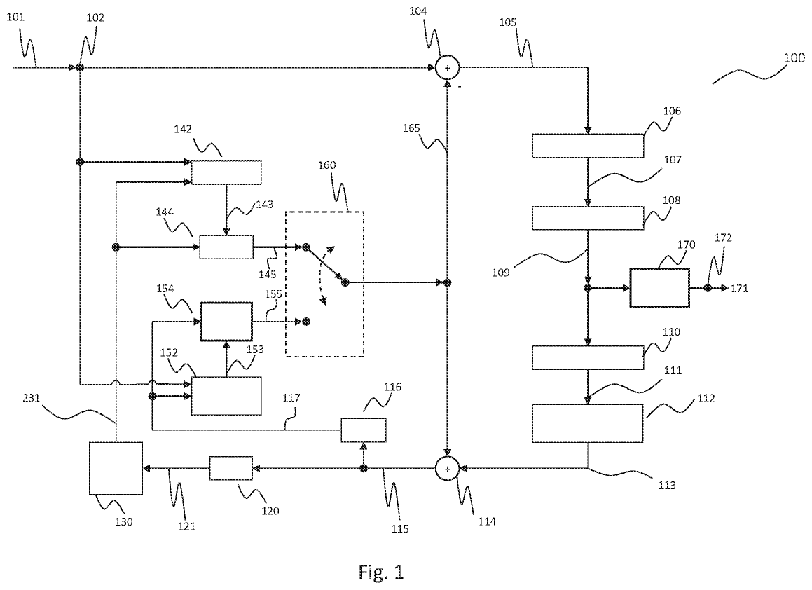

FIG. 1 shows a schematic block diagram of an embodiment of an encoder 100, e.g. a picture encoder 100, which comprises an input 102, a residual calculation unit 104, a transformation unit 106, a quantization unit 108, an inverse quantization unit 110, and inverse transformation unit 112, a reconstruction unit 114, a buffer 118, a loop filter 120, a decoded picture buffer (DPB) 130, an inter estimation unit 142, an inter prediction unit 144, an intra-estimation unit 152, an intra-prediction unit 154, a mode selection unit 160, an entropy encoding unit 170, and an output 172.

A video encoder 100 as shown in FIG. 1 may also be referred to as hybrid video encoder or a video encoder according to a hybrid video codec.

The encoder is configured to receive, e.g. by input 102, a picture 101 or a block 101 of the picture, e.g. picture of a sequence of pictures forming a video or video sequence. The block 101 may also be referred to as current picture block or picture block to be coded, and the picture 101 as current picture or picture to be coded (in particular in video coding to distinguish the current picture from other pictures, e.g. previously encoded and/or decoded pictures of the same video sequence, i.e. the video sequence which also comprises the current picture).

Like the picture 101, the block 101 is or can be regarded as a two-dimensional array or matrix of samples with intensity values (sample values), although of smaller dimension than the picture 101. In other words, the block 101 may comprise, e.g., one sample array (e.g. a luma array in case of a monochrome picture 101) or three sample arrays (e.g. a luma and two chroma arrays in case of a color picture 101) or any other number and/or kind of arrays depending on the color format applied. The number of samples in horizontal and vertical direction (or axis) of the block 101 define the size of block 101.

The residual calculation unit 104 is configured to calculate a residual block 105 based on the block 101 and a prediction block 165 (further details about the prediction block 165 are provided later), e.g. by subtracting sample values of the prediction block 165 from sample values of the block 101, sample by sample (pixel by pixel) to obtain the residual block 105 in the sample domain.

The transformation unit 106 may be configured to apply integer approximations of DCT/DST, such as the core transforms specified for HEVC/H.265. Compared to an orthonormal DCT transform, such integer approximations are typically scaled by a certain factor. In order to preserve the norm of the residual block which is processed by forward and inverse transforms, additional scaling factors are applied as part of the transform process. The scaling factors are typically chosen based on certain constraints like scaling factors being a power of two for shift operation, bit depth of the transformed coefficients, tradeoff between accuracy and implementation costs, etc. Specific scaling factors are, for example, specified for the inverse transform, e.g. by inverse transformation unit 212, at a decoder 200 (and the corresponding inverse transform, e.g. by inverse transformation unit 112 at an encoder 100) and corresponding scaling factors for the forward transform, e.g. by transformation unit 106, at an encoder 100 may be specified accordingly.

The quantization unit 108 is configured to quantize the transformed coefficients 107 to obtain quantized coefficients 109, e.g. by applying scalar quantization or vector quantization. The quantized coefficients 109 may also be referred to as quantized residual coefficients 109. For example for scalar quantization, different scaling may be applied to achieve finer or coarser quantization.

The inverse quantization unit 110 is configured to apply the inverse quantization of the quantization unit 108 on the quantized coefficients to obtain dequantized coefficients 111. The dequantized coefficients 111 may also be referred to as dequantized residual coefficients 111 and correspond—although typically not identical to the transformed coefficients due to the loss by quantization—to the transformed coefficients 108.

The inverse transformation unit 112 is configured to apply the inverse transformation of the transformation applied by the transformation unit 106, e.g. an inverse discrete cosine transform (DCT) or inverse discrete sine transform (DST), to obtain an inverse transformed block 113 in the sample domain. The inverse transformed block 113 may also be referred to as inverse transformed dequantized block 113 or inverse transformed residual block 113.

The reconstruction unit 114 is configured to combine the inverse transformed block 113 and the prediction block 165 to obtain a reconstructed block 115 in the sample domain, e.g. by sample wise adding the sample values of the decoded residual block 113 and the sample values of the prediction block 165.

The buffer unit 116 (or short “buffer” 116), e.g. a line buffer 116, is configured to buffer or store the reconstructed block and the respective sample values, for example for intra estimation and/or intra prediction.

The loop filter unit 120 (or short “loop filter” 120), is configured to filter the reconstructed block 115 to obtain a filtered block 121, e.g. by applying a de-blocking sample-adaptive offset (SAO) filter or other filters, e.g. sharpening or smoothing filters or collaborative filters. The filtered block 121 may also be referred to as filtered reconstructed block 121.

The decoded picture buffer (DPB) 130 is configured to receive and store the filtered block 121. The decoded picture buffer 130 may be further configured to store other previously filtered blocks, e.g. previously reconstructed and filtered blocks 121, of the same current picture or of different pictures.

The inter estimation unit 142, also referred to as inter picture estimation unit 142, is configured to receive or obtain the picture or block 101 (current block 101) and a decoded picture 231, or at least one or a plurality of previously reconstructed blocks, e.g. reconstructed blocks of one or a plurality of other/different previously decoded pictures 231, for inter estimation (or “inter picture estimation”). E.g. a video sequence may comprise the current picture and the previously decoded pictures 231, or in other words, the current picture and the previously decoded pictures 231 may be part of or form a sequence of pictures forming a video sequence.

The inter prediction unit 144 is configured to obtain, e.g. receive, an inter prediction parameter 143 and to perform inter prediction based on or using the inter prediction parameter 143 to obtain an inter prediction block 145.

The intra estimation unit 152 is configured to obtain, e.g. receive, the picture block 101 (current picture block 101) and one or a plurality of previously reconstructed blocks, e.g. reconstructed neighbor blocks, of the same picture for intra estimation. The encoder 100 may, e.g., be configured to determine an intra prediction mode from a plurality of (predetermined) intra prediction modes and provide it as intra prediction parameter 153 to the intra prediction unit 154.

The intra prediction unit 154 is configured to determine based on the intra prediction parameter 153, e.g. the selected intra prediction mode 153, the intra prediction block 155.

Mode selection unit 160 may be configured to select a prediction mode (e.g. an intra or inter prediction mode) and/or a corresponding prediction block 145 or 155 to be used as prediction block 165 for the calculation of the residual block 105 and for the reconstruction of the reconstructed block 115.

The entropy encoding unit 170 is configured to apply an entropy encoding algorithm or scheme (e.g. a variable length coding (VLC) scheme, an context adaptive VLC scheme (CALVC), an arithmetic coding scheme, a context adaptive binary arithmetic coding (CABAC)) on the quantized residual coefficients 109, inter prediction parameters 143, intra prediction parameter 153, and/or loop filter parameters, individually or jointly (or not at all) to obtain encoded picture 171 which can be output by the output 172, e.g. in the form of an encoded bit stream 171.

In the following the prediction processing performed by an example encoder 100 will be explained in more detail.

As described above, encoder 100 is configured to determine or select the best or an optimum prediction mode from a set of (pre-determined) prediction modes. The set of prediction modes may comprise, e.g., intra-prediction modes and/or inter-prediction modes.

The set of intra-prediction modes may comprise 32 different intra-prediction modes, e.g. non-directional modes like DC (or mean) mode and planar mode, or directional modes, e.g. as defined in H.264, or may comprise 65 different intra-prediction modes, e.g. non-directional modes like DC (or mean) mode and planar mode, or directional modes, e.g. as defined in H.265. Additional to these prediction modes, skip mode and/or direct mode may be applied.

Although FIG. 1 shows two distinct units (or steps) for the intra-coding, namely intra estimation 152 and intra prediction 154, both functionalities may be performed as one. Intra estimation comprises calculating the intra prediction block, i.e. the or a “kind of” intra prediction 154, e.g. by testing all possible or a predetermined subset of possible intra-prediction modes iteratively while storing the currently best intra prediction mode and respective intra prediction block, and using the currently best intra prediction mode and respective intra prediction block as the (final) intra prediction parameter 153 and intra prediction block 155 without performing another time the intra prediction 154.

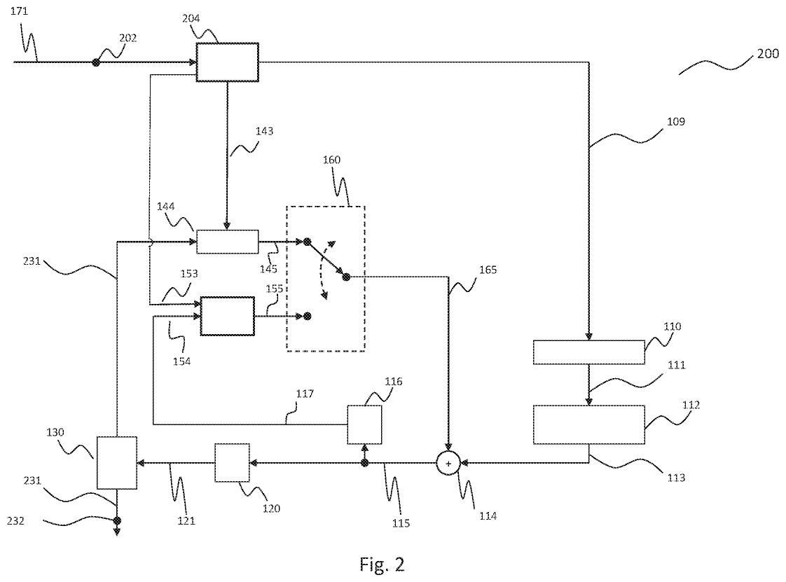

FIG. 2 shows an exemplary video decoder 200 for reconstructing a block 101 or current block 101 of an encoded picture (e.g. encoded bit stream) 171, e.g. encoded by encoder 100, to obtain a decoded picture 231.

In the following identical reference signs used in FIG. 2 for units of the decoder 200 refer to identical or at least functionally equivalent features of the units of the encoder 100 described according to FIG. 1.

The decoder 200 comprises an input 202, an entropy decoding unit 204, an inverse quantization unit 110, an inverse transformation unit 112, a reconstruction unit 114, a buffer 116, a loop filter 120, a decoded picture buffer 130, an inter prediction unit 144, an intra prediction unit 154, a mode selection unit 160 and an output 232.

The entropy decoding unit 204 is configured to perform entropy decoding to the encoded picture 171 to obtain, e.g., quantized coefficients 109 and/or decoded coding parameters (not shown in FIG. 2).

In embodiments of the decoder 200, the inverse quantization unit 110, the inverse transformation unit 112, the reconstruction unit 114, the buffer 116, the loop filter 120, the decoded picture buffer 130, the inter prediction unit 144, the intra prediction unit 154 and the mode selection unit 260 are configured to perform the inverse processing of the encoder 100 and the respective functional units to decode the encoded picture 171.

The inter prediction unit 144 and the intra prediction unit 154 and the mode selection unit 160 are typically configured to perform the block prediction and/or obtain the predicted block 165 from the encoded picture 171 only and to receive or obtain (explicitly or implicitly) the prediction parameters 143 or 153 and/or the information about the selected prediction mode, e.g. from the entropy decoding unit 204.

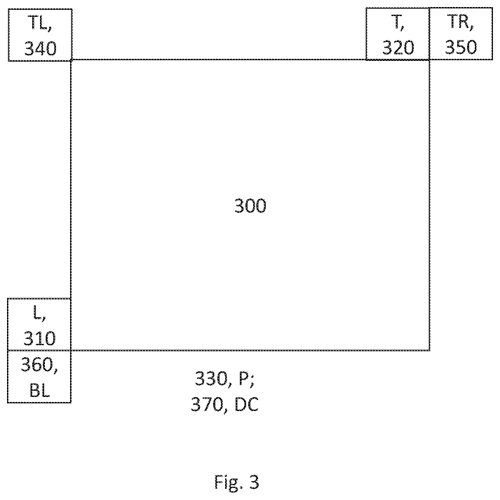

FIG. 3 shows a schematic diagram showing an example order of neighboring blocks used for reconstructing a current block of an encoded picture according to an embodiment of the disclosure.

When reconstructing the current block 300 the necessary intra-prediction modes are determined by using reference modes from the reconstructed neighboring blocks 310, 320, 340, 350, 360 as shown in FIG. 3.

For example, for reconstructing the current block 300 of an encoded picture a decoder 200 is configured to generate a most probable modes (MPM) candidates list for the current block 300. The MPM candidates list comprises seven elements, wherein the seven elements of the MPM candidates list are listed in an order, an intra-prediction mode associated with a left neighboring block 310 of the current block 300 as the first element, an intra-prediction mode associated with a top neighboring block 320 of the current block 300 as the second element, a planar mode 330 as the third element, an intra-prediction mode associated with a top-left neighboring block 340 of the current block 300 as the fourth element, an intra-prediction mode associated with a top-right neighboring block 350 of the current block 300 as fifth element, a bottom-left neighboring block 360 of the current block 300 as the sixth element and a DC mode 370 as the seventh element. The decoder 200 is further configured to prune the MPM candidates list, thereby generating an MPM list, and to intra-predict the current block 300 based on the MPM list.

For example, neighbor intra prediction modes are used to form the MPM candidates list. The locations of these neighbor intra prediction modes are ordered as follows: Left 310 (L), Top 320 (T), PLANAR 330, Top Left 340 (TL), Top Right 350 (TR), BOTTOM LEFT 360 (BL), and DC 370. Even if the number of modes in the MPM candidates list or MPM list is changed, the order of the insertion of the modes is kept the same.

If the MPM candidates list is not completely filled, then further derived modes are added. For example, those Intra modes are obtained by adding offset values to the angular modes which are already included into MPM list. Such a derivation is not applied to non-angular modes like for example DC or Planar mode. If MPM list is still not complete, default modes are added in the order of: vertical, horizontal, mode 2, and diagonal mode.

For example, 16 selected modes and first 14 non-selected modes list are incorporated by adding angular offsets only to the first two angular modes from the MPM list. The remaining 5 non selected modes are incorporated from a default mode list, which is ordered based on the respective intra mode occurrence probability. For example, the Default mode list is ordered as follows: {PLANAR_IDX, DC_IDX, VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

There are different prediction methods available for reconstructing a picture 300 or a block 300, when decoding or encoding. The angular intra prediction can be used to model different directional structures typically present in pictures, Planar (P) and DC prediction modes provide predictions for image areas with smooth and gradually changing content. Planar and DC predictions are also useful in creating “neutral” prediction blocks with no high frequency components for complex textures that cannot be properly modeled with any one of the directional intra prediction modes that the angular intra prediction is able to generate.

Angular intra prediction is defined to model different directional structures typically present in a sequence of pictures, e.g. video, or still picture. The set of available prediction directions has been selected to provide a good trade-off between encoding complexity and coding efficiency. The prediction process based on the reconstructed neighboring blocks 310, 320, 340, 350, 360 is designed to have low computational requirements and to be consistent across different block sizes and prediction directions.

The DC mode 370, which is used in case of DC prediction is to be understood as populating the predicted sample values with a constant value representing the average of the reference samples left 310 and top 320 of the current block 300 to be predicted.

While angular prediction provides good approximations for structures with significant edges, it can create some visible contouring in smooth image areas. The planar prediction mode 330 is designed to overcome such issues by having the capability to generate a prediction surface without discontinuities on the block boundaries. This is achieved by averaging a horizontal and vertical linear prediction as follows: the top-right reference 350 is used as the right reference for all the horizontal filtering. Similarly, the bottom-left reference 360 is used as the bottom reference for all the vertical operations. The final planar prediction mode for each sample is obtained by averaging the horizontal and vertical intra prediction modes.

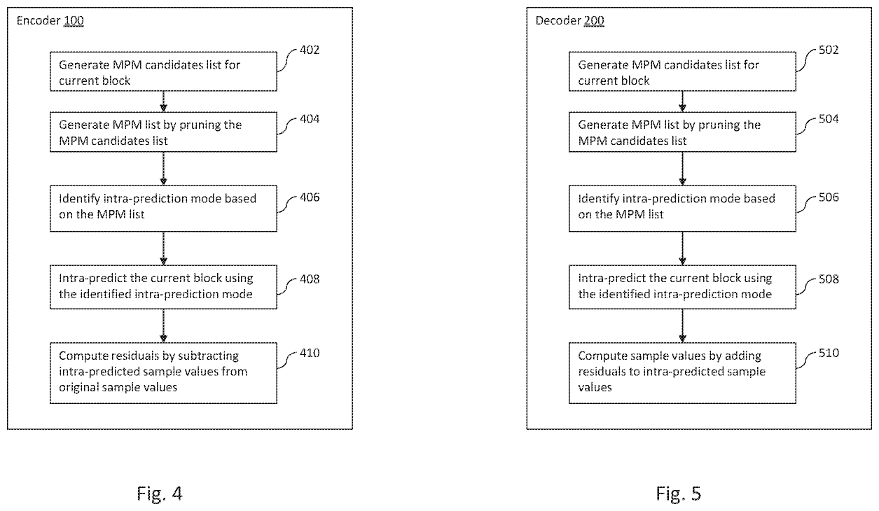

FIG. 4 schematically illustrates an example embodiment of the encoder 100. In this example, the encoder 100 is configured to generate an MPM candidates list for a current block (step 402). The MPM candidates list may be defined as described above. The encoder 100 further generates an MPM list by pruning the MPM candidates list (step 404), and to identify an intra-prediction mode for the current block based on the MPM list (step 406). The encoder 100 intra-predicts the current block using the identified intra-prediction mode (step 408) and computes residuals for the current block by subtracting intra-predicted sample values of the current block from original sample values of the current block (step 410). The encoder 100 further encodes the residuals in a bit sequence that can be decoded by a decoder.

FIG. 5 schematically illustrates an example embodiment of the decoder 100 for decoding a compressed picture. In this example, the decoder 200 is configured to generate an MPM candidates list for a current block of the picture (step 502). The MPM candidates list may be defined as described above. The decoder 200 further generates an MPM list by pruning the MPM candidates list (step 504), and to identify an intra-prediction mode for the current block based on the MPM list (step 506). The decoder 200 extracts residuals for the current block from the compressed representation of the picture and intra-predicts the current block using the identified intra-prediction mode (step 508). The decoder 200 further computes sample values of the current block by adding residuals to intra-predicted sample values of the current block.

Although embodiments of the disclosure have been primarily described based on video coding, it should be noted that embodiments of the encoder 100 and decoder 200 may also be configured for still picture processing or coding, i.e. the processing or coding of an individual picture independent of any preceding or consecutive picture as in video coding. In general only inter-estimation 142, inter-prediction 144 are not available in case the picture processing coding is limited to a single picture 101. Most if not all other functionalities (also referred to as tools or technologies) of the encoder 100 and decoder 200 may equally be used for still pictures, e.g. partitioning, transformation (scaling) 106, quantization 108, inverse quantization 110, inverse transformation 112, intra-estimation 142, intra-prediction 154 and/or loop filtering 120, and entropy coding 170 and entropy decoding 204.

The person skilled in the art will understand that the “blocks” (“units”) of the various figures (method and apparatus) represent or describe functionalities of embodiments of the disclosure (rather than necessarily individual “units” in hardware or software) and thus describe equally functions or features of apparatus embodiments as well as method embodiments (unit=step).

The terminology of “units” is merely used for illustrative purposes of the functionality of embodiments of the encoder/decoder and are not intended to limiting the disclosure. The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments. In addition, functional units in the embodiments of the present disclosure may be integrated into one processing unit, or each of the units may exist alone physically, or two or more units are integrated into one unit.

Embodiments of the encoder 100 and/or decoder 200 may be implemented as hardware, firmware, software or any combination thereof. For example, the functionality of the encoder/encoding or decoder/decoding may be performed by a processing circuitry with or without firmware or software, e.g. a processor, a microcontroller, a digital signal processor (DSP), a field programmable gate array (FPGA), an application-specific integrated circuit (ASIC), or the like.

The functionality of the encoder 100 (and corresponding encoding method) and/or decoder 200 (and corresponding decoding method) may be implemented by program instructions stored on a computer readable medium. The program instructions, when executed, cause a processing circuitry, computer, processor or the like, to perform the steps of the encoding and/or decoding methods. The computer readable medium can be any medium, including non-transitory storage media, on which the program is stored such as a Blue ray disc, DVD, CD, USB (flash) drive, hard disc, server storage available via a network, etc.

An embodiment of the disclosure comprises or is a computer program for reconstructing a current block of a picture comprising program code for performing any one of the methods described herein, when executed on a computer.

### LIST OF REFERENCE SIGNS

### FIG. 1

100 Encoder
101 Picture, block, current block
102 Input (e.g. input port, input interface)
104 Residual calculation [unit or step]
105 Residual block
106 Transformation (e.g. additionally comprising scaling) [unit or step]
107 Transformed coefficients
108 Quantization [unit or step]
109 Quantized coefficients
110 Inverse quantization [unit or step]
111 De-quantized coefficients
112 Inverse transformation (e.g. additionally comprising scaling) [unit or step]
113 Inverse transformed block
114 Reconstruction [unit or step]
115 Reconstructed block
116 (Line) buffer [unit or step]
117 Reference samples
120 Loop filter [unit or step]
121 Filtered block
130 Decoded picture buffer (DPB) [unit or step]
142 Inter estimation (or inter picture estimation) [unit or step]
143 Inter estimation parameters (e.g. reference picture/reference picture index, motion vector/offset)
144 Inter prediction (or inter picture prediction) [unit or step]
145 Inter prediction block
152 Intra estimation (or intra picture estimation) [unit or step]
153 Intra prediction parameters (e.g. intra prediction mode)
154 Intra prediction (intra frame/picture prediction) [unit or step]
155 Intra prediction block
160 Mode selection [unit or step]
165 Prediction block (either inter prediction block 145 or intra prediction block 155)
170 Entropy encoding [unit or step]
171 Encoded picture (e.g. bit stream)
172 Output (output port, output interface)
231 Decoded picture

### FIG. 2

200 Decoder
171 Encoded picture (e.g. bit stream)
202 Input (port/interface)
204 Entropy decoding
109 Quantized coefficients
110 Inverse quantization
111 De-quantized coefficients
112 Inverse transformation (scaling)
113 Inverse transformed block
214 Reconstruction (unit)
115 Reconstructed block
116 (Line) buffer
117 Reference samples
120 Loop filter (in loop filter)
121 Filtered block
130 Decoded picture buffer (DPB)
231 Decoded picture
232 Output (port/interface)
144 Inter prediction (inter frame/picture prediction)
145 Inter prediction block
154 Intra prediction (intra frame/picture prediction)
155 Intra prediction block
160 Mode selection
165 Prediction block (inter prediction block 245 or intra prediction block 255)

### FIG. 3

300 picture block, block
310 intra prediction mode associated with left neighboring block
320 intra prediction mode associated with top neighboring block
330 Planar mode
340 intra prediction mode associated with top-left neighboring block
350 intra prediction mode associated with top-right neighboring block
360 intra prediction mode associated with bottom-left neighboring block
370 DC mode

1. A device, wherein the device is a decoder or an encoder,
the device comprising a processing circuitry configured to:
generate a most probable modes (MPM) candidates list for the current block, the MPM candidates list comprising four or more elements, wherein the first four elements of the MPM candidates list are, in this order:
an intra-prediction mode associated with a left neighboring block of the current block,
an intra-prediction mode associated with a top neighboring block of the current block,
a planar mode, and
an intra-prediction mode associated with a top-left neighboring block of the current block,
prune the MPM candidates list, thereby generating an MPM list, and
intra-predict the current block based on the MPM list.

2. The device according to claim 1, wherein the MPM candidates list comprises five or more elements, the fifth element of the MPM candidates list being an intra-prediction mode associated with a top-right neighboring block of the current block.

3. The device according to claim 1,
wherein the MPM candidates list comprises six or more elements, the sixth element of the MPM candidates list being a bottom-left neighboring block of the current block.

4. The device according to claim 1,
wherein the MPM candidates list comprises seven or more elements, the seventh element of the MPM candidates list being a DC mode.

5. A device, wherein the device is an encoder or a decoder,
the device comprising a processing circuitry configured to:
generate a most probable modes (MPM) candidates list for the current block, the MPM candidates list comprising, in this order:
a first list comprising one or more intra-prediction modes associated with neighboring blocks of the current block, a planar mode, and a DC mode,
if the first list comprises one or more angular modes, then a second list which comprises zero, one or more angular modes, and
a default mode list which comprises, in the following order: a vertical intra-prediction mode, a horizontal intra-prediction mode, an intra-prediction mode 2, and a vertical-diagonal (VDIA) intra-prediction mode,
and
prune the MPM candidates list, thereby generating an MPM list, and
intra-predict the current block based on the MPM list.

6. The decoder according to claim 5, wherein the first thirteen members of the default mode list are the following, in this order:
{VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1}.

7. The decoder according to claim 5, wherein the first sixty-five members of the default mode list are the following, in this order:
{VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

8. A device, wherein the device is a decoder or an encoder,
the device comprising a processing circuitry configured to:
generate a selected and non-selected modes list for the current block,
wherein generating the selected and non-selected modes list comprises, when a most probable modes (MPM) list comprises one or two angular modes:
incorporate one or more angular modes into the selected and non-selected modes list by adding integer multiples of an integer constant to a first angular mode, the first angular mode being the angular mode that comes first in the MPM list,
incorporate one or more angular modes to the selected and non-selected modes list by adding integer multiples of the integer constant to a second angular mode, the second angular mode being the angular mode that comes second in the MPM list, and
intra-predict the current block based on the selected and non-selected modes list.

9. The device according to claim 8,
wherein the selected and non-selected modes list comprises, in this order, a selected modes list and a non-selected modes list, and wherein the processing circuitry is configured to:
complete the non-selected modes list by filling it from a default mode list, wherein the default mode list is:
{VER_IDX, HOR_IDX, 2, VDIA_IDX, VER_IDX−1, VER_IDX+4, VER_IDX+1, VER_IDX−5, VER_IDX−4, HOR_IDX−4, HOR_IDX−6, HOR_IDX−3, HOR_IDX−1, 10, 58, 19, 13, 22, 23, 53, 55, 41, 11, 62, 24, 37, 34, 42, 43, 47, 16, 33, 44, 25, 48, 26, 21, 28, 30, 56, 29, 52, 35, 20, 27, 38, 32, 6, 9, 7, 31, 39, 40, 36, 8, 3, 60, 59, 57, 61, 4, 64, 5, 65, 63}.

10. The device according to claim 9,
wherein the integer constant is one.

11. The device according to claim 9,
wherein the integer constant is two.
